(19) United States
(12) Patent Application Publication
(10) Pub. No.: US 2004/0076098 A1
(43) Pub. Date: Apr. 22, 2004

(54) Apparatus and method detecting fashion disc

(75) Inventor: Bong-Hwoan Choi, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/603,863

(22) Filed: Jun. 26, 2003

(30) Foreign Application Priority Data
Oct. 18, 2002 (KR) 2002-63849

(51) Int. Cl. G11B 7/00

(52) U.S. Cl. 369/53.23

(57) ABSTRACT

An apparatus and method detecting a fashion disc, which can detect fashion discs having various shapes as well as standard discs having a diameter of 12 cm and prevent instability when reproducing the fashion discs. The method includes (a) detecting the size of an optical disc inserted in an optical disc drive by sensing the weight of the optical disc and driving the optical disc drive; (b) determining the size of the optical disc by detecting an amount of data recorded on the optical disc from a lead-in area of the optical disc; (c) if the amount of data recorded on the optical disc is below a reference value, moving a pickup to a periphery area and measuring a focus error; and (d) if the measured focus error is above a constant value, detecting the optical disc as a certain optical disc and limiting the operational speed level of the optical disc drive.

### CROSS-REFERENCE TO RELATED APPLICATIONS

This application claims the priority of Korean Patent Application No. 2002-63849, filed on Oct. 18, 2002, in the Korean Intellectual Property Office, the disclosure of which is incorporated herein in its entirety by reference.

### BACKGROUND OF THE INVENTION

1. Field of the Invention

The present invention relates to an apparatus and method operating an optical disc drive, and more particularly, to an apparatus and method detecting a fashion disc, which can detect fashion discs having various shapes and prevent instability when reproducing the fashion discs.

2. Description of the Related Art

Generally, an optical recording medium, such as a CD, a DVD-S, or a DVD-D, has a diameter of 12 cm and a thickness of 1.2 mm or 0.6 mm. In comparison with a magnetic recording medium, such as a floppy disc having a data storage capacity below 2 mega-bytes, the optical recording medium has a very large data storage capacity of hundreds of mega-bytes reaching hundreds of times of the capacity of the floppy disc. A data recording area of the optical recording medium includes a reflective surface reflecting light and pits concavely formed in the reflective surface area. The optical recording medium stores information, such as audio, characters, graphics, etc., using combinations of the pits. There has been continuous improvement in the development of optical disc reproducing apparatuses precisely reproducing optical discs at high speeds without errors in reading data stored thereon at very high density.

Further, improvements in compatibility of optical disc reproducing apparatuses of various types allow users to compatibly reproduce any type of optical discs using only one optical disc reproducing apparatus.

In addition to a standard optical disc having a diameter of 12 cm as shown in FIG., various types of optical discs, i.e., fashion discs, having diameters of 8 cm and various shapes, such as a star, a flower, or a business card shape as shown in FIGS. 1B through 1D, are now available.

When a fashion disc is inserted in a conventional disc drive, the inserted fashion disc is assumed to be a standard optical disc having a diameter of 12 cm. However, the non-standard configuration of the fashion disc rotating at a high speed, i.e., the same speed of that for the standard disc, causes very serious noise and a failure of a lead-in operation is caused due to a focus drop or an adjustment failure. That is,,the reproduction of the fashion disc has caused instability of a conventional optical disc reproducing apparatus.

### SUMMARY OF THE INVENTION

The present invention provides an apparatus and method detecting a fashion disc, which can detect fashion discs having various shapes as well as standard discs having a diameter of 12 cm and prevent instability when reproducing the fashion discs.

According to an aspect of the present invention, a method of detecting a fashion disc includes (a) detecting the size of an optical disc inserted in an optical disc drive by sensing the weight of the optical disc and driving the optical disc drive; (b) determining the size of the optical disc by detecting an amount of data recorded on the optical disc from a lead-in area of the optical disc; (c) if the amount of data recorded on the optical disc, the size of which has been determined, is below a reference value, moving a pickup to a periphery area and measuring a focus error; and (d) if the measured focus error is above a constant value, detecting the optical disc as a certain optical disc and limiting the operational speed level of the optical disc drive.

The optical disc detected according to the weight thereof in operation (a) is either a standard disc having a diameter of 12 cm or a fashion disc having a diameter of 8 cm.

The optical disc determined according to the amount of data recorded on the optical disc in operation (b) is any one disc among a standard disc having a diameter of 12 cm on which data is fully recorded, a standard disc having a diameter of 12 cm on which data is partially recorded, and a fashion disc having a diameter of 8 cm.

The certain optical disc detected in operation (d) is a fashion disc having a diameter of 8 cm.

If it is determined in operation (d) that the measured focus error is below the constant value, the optical disc is detected as a standard disc having a diameter of 12 cm on which data is partially recorded.

According to another aspect of the present invention, an apparatus detecting a fashion disc includes a weight detection unit detecting the weight of an optical disc inserted in a disc drive; a comparison unit comparing an amount of data recorded on the optical disc from the lead-in area of the optical disc with a reference value; and a disc detection unit (a) detecting the size of an optical disc according to the weight detected via the weight detection unit; (b) determining the size of the optical disc by detecting the amount of data recorded on the optical disc from the lead-in area of the optical disc when the disc drive is driven; (c) if it is determined as a result of the comparison via the comparison unit that the amount of data recorded on the optical disc is below the reference value, moving a pickup to a periphery area and measuring a focus error; and (d) if the measured focus error is above a constant value, detecting the optical disc as a certain optical disc.

The detection unit includes a first disc detection unit that detects the size of the disc according to the weight detected via the weight detection unit; a second disc detection unit that determines the size of the optical disc by detecting the amount of data recorded on the optical disc from the lead-in area of the optical disc when the disc drive is driven; and a third disc detection unit that moves the pickup to the periphery area and measures the focus error, if it is determined as the result of the comparison via the comparison unit that the amount of data recorded on the optical disc is below the reference value, and detects the optical disc as the certain optical disc, if the measured focus error is above the constant value.

The first disc detection unit detects the optical disc as either a standard disc having a diameter of 12 cm or a fashion disc having a diameter of 8 cm according to the weight of the optical disc.

The second disc detection unit detects the optical disc as any one disc among a standard disc having a diameter of 12 cm on which data is fully recorded, a standard disc having a diameter of 12 cm on which data is partially recorded, and a fashion disc having a diameter of 8 cm according to the amount of data recorded on the optical disc.

The third disc detection unit detects the optical disc as a certain optical disc predetermined as a fashion disc having a diameter of 8 cm if the measured focus error is below the constant value and as a standard disc having a diameter of 12 cm on which data is partially recorded if the measured focus error is above the constant value.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent by describing embodiments thereof with reference to the attached drawings in which:

FIGS. 1A through 1D shows examples of a standard disc having a diameter of 12 cm and various fashion discs having diameter of 8 cm;

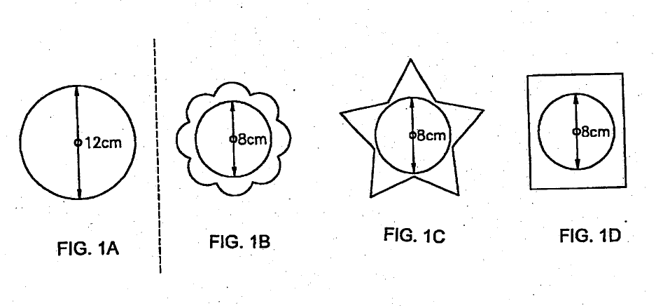

FIG. 2 is a block diagram of an apparatus detecting a fashion disc according to an embodiment of the present invention; and

FIG. 3 is a flowchart of a method of detecting a fashion disc according to an embodiment the present invention.

### DETAILED DESCRIPTION OF THE PREFERRED EMBODIMENTS

Preferred embodiments of the present invention will now be described with reference to the attached drawings, wherein like reference numerals refer to like elements throughout.

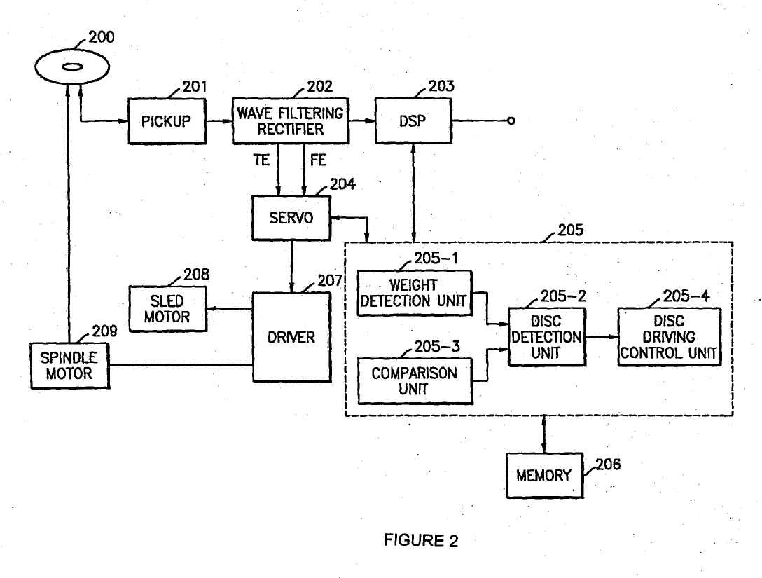

FIG. 2 is a block diagram of an apparatus detecting a fashion disc according to an embodiment of the present invention. Briefly, the apparatus utilizes an optical disc 200 and includes a pickup 201, a wave filtering rectifier 202, a digital signal processor (DSP) 203, a servo 204, a memory 206, a driver 207, a sled motor 208, a spindle motor 209, and a controller 205 comprised of a weight detection unit 205-1, a disc detection unit 205-2, a comparison unit 205-3, and a disc driving control unit 205-4.

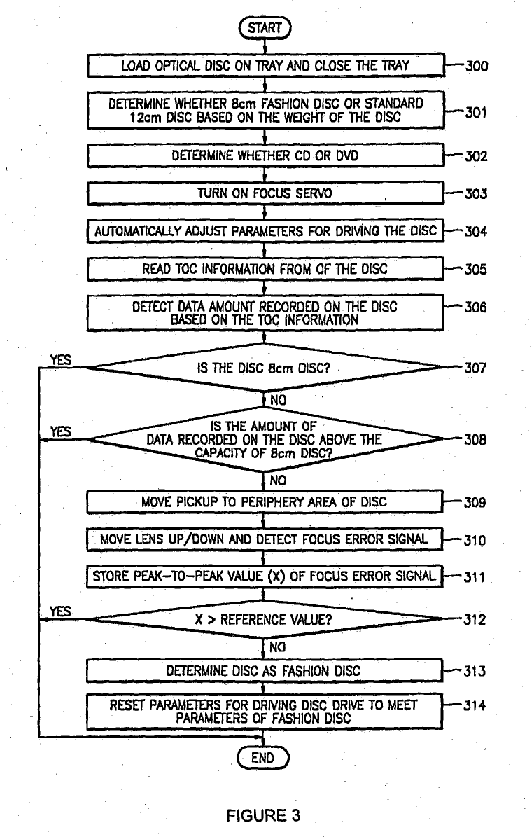

FIG. 3 is a flowchart of a method of detection a fashion disc according to the present invention. Briefly, the method includes the operations of loading an optical disc on a tray and closing the tray (OPERATION 300), distinguishing the type of the optical disc between a fashion disc having a diameter of 8 cm and a standard disc having a diameter of 12 cm based on the weight of the optical disc (OPERATION 301), distinguishing the type of the optical disc between a CD and a DVD (OPERATION 302), turning on a focus servo (OPERATION 303), automatically adjusting parameters driving the optical disc (OPERATION 304), reading TOC information from the optical disc (OPERATION 305), detecting an amount of data recorded on the optical disc based on the TOC information (OPERATION 306), determining whether the optical disc is an 8 cm fashion disc (OPERATION 307), determining whether an amount of data recorded on the optical disc is above the capacity of the 8 cm fashion disc (OPERATION 308), moving a pickup to the periphery area of the optical disc (OPERATION 309), detecting a focus error (FE) signal while moving a focus lens up and down (OPERATION 310), storing a peak-to-peak value X of the FE signal (OPERATION 311), determining whether the value X is above a reference value (OPERATION 312), determining the type of the optical disc as an 8 cm fashion disc (OPERATION 313), and resetting the parameters driving the optical disc to meet the operating conditions required for the fashion disc (OPERATION 314).

The apparatus and method shown in FIGS. 2 and 3 will now be described in more detail.

After loading the optical disc 200 on a tray (not shown), the tray is closed (OPERATION 300). When the tray loading the optical disc 200 is closed, the pickup 201 reads signals recorded on the optical disc 200. The wave filtering rectifier 202 adds or subtracts the electrical signals output from the pickup 201 and outputs an RF signal, a focus error (FE) signal, and a tracking error (TE) signal. The DSP 203 decodes the RF signal output from the wave filtering rectifier 202 into a digital signal and performs a reproduction signal process. The sled motor 208 moves the pickup 201 and the spindle motor 209 rotates the optical disc 200. The driver 207 drives the sled motor 208 and the spindle motor 209. The servo 204 controls the operations of the pickup 201 and the driver 207.

The controller 205 distinguishes the type of the optical disc 200 between an 8 cm fashion disc and a 12 cm standard disc based on the weight of the optical disc (OPERATION 301). In a tray-in mode of the tray loading the optical disc 200, the weight detection unit 205-1 detects the weight of the optical disc 200 and outputs a weight detection signal to the disc detection unit 205-2. The disc detection unit 205-2 distinguishes the type of the optical disc 200 between an 8 cm fashion disc and a 12 cm standard disc based on the weight detection signal output from the weight detection unit 205-1.

After distinguishing the type of the optical disc 200 between an 8 cm fashion disc and a 12 cm standard disc, the disc detection unit 205-2 further distinguishes the type of the optical disc 200 between a CD and a DVD (OPERATION 302). The disc detection unit 205-2 can distinguish the type of the optical disc 200 between a CD and a DVD based on the thickness of the optical disc 200 or using the value of the FE signal output from the wave filtering rectifier 202.

After distinguishing the type of the optical disc 200 between a CD and a DVD, the controller 205 turns on a focus servo (not shown) within the servo 204 (OPERATION 303).

When the focus servo is turned on, the controller 205 automatically adjusts parameters driving the optical disc 200 (OPERATION 304). The disc driving control unit 205-4 controls an overall operation driving the optical disc 200. That is, the disc driving control unit 205-4 turns on a tracking servo (not shown) and a CLB servo (not shown) within the servo 204 and adjusts the parameters driving the optical disc 200, such as balance and a loop gain.

After adjusting the parameters driving the optical disc 200, the pickup 201 reads TOC information from the optical disc 200 (OPERATION 305).

The controller 205 detects an amount of data recorded on the optical disc 200 based on the TOC information (OPERATION 306). The comparison unit 205-3 compares the detected amount of data recorded on the optical disc 200 with reference data amounts stored in the memory 206 and outputs the comparison result to the disc detection unit 205-2. The reference data amounts can be an amount of data recordable on a 12 cm standard disc and an amount of data 8 cm fashion disc. In another implementation, the controller 205 detects the data recording capacity of the optical disc 200 in OPERATION 306.

The disc detection unit 205-2 determines whether the optical disc 200 is an 8 cm fashion disc (OPERATION 307). If the optical disc 200 is determined as the 8 cm fashion disc via the disc detection unit 205-2, the disc detection process ends.

However, if the disc detection unit 205-2 determines that the optical disc 200 is not the 8 cm fashion disc, the disc detection unit 205-2 examines whether the amount of data recorded on the optical disc 200 is above the capacity of an 8 cm fashion disc (OPERATION 308). In this case, the optical disc 200 can be any one disc among a 12 cm standard disc on which data is fully recorded, a 12 cm standard disc on which data is partially recorded, and an 8 cm fashion disc. If the amount of data recorded on the optical disc 200 is above the capacity of an 8 cm fashion disc, the optical disc 200 is determined as a 12 cm standard disc on which data is fully recorded or a 12 cm standard disc on which data is partially recorded and the disc detection process ends.

If the amount of data recorded on the optical disc 200 is below the capacity of an 8 cm fashion disc, the controller 205 moves the pickup 204 to the periphery area of the optical disc 200 (OPERATION 309). In this case, the optical disc can be either a 12 cm standard disc on which data is partially recorded or an 8 cm fashion disc. In a case of the 12 cm standard disc on which data is partially recorded, the moved pickup 201 is placed within a data recording area. However, in a case of the 8 cm fashion disc, the moved pickup 201 is placed outside a data recording area.

After the pickup 201 is moved to the periphery area of the optical disc 200, the focus lens is moved up and down and a focus error (FE) signal is detected (OPERATION 310).

The peak-to-peak value X of the detected FE signal is stored in the memory 206 (OPERATION 311).

Then, it is determined whether the peak-to-peak value X of the FE signal is greater than a reference value (OPERATION 312). The comparison unit 205-3 compares the peak-to-peak value X of the FE signal output from the wave filtering rectifier 202 according to the moving of the focus lens with the reference value stored in the memory 206 and outputs the comparison result to the disc detection unit 205-2. If the peak-to-peak value X of the FE signal is greater than the reference value, the disc detection unit 205-2 determines that the optical disc 200 is a 12 cm standard on which data is partially recorded and the disc detection process ends.

However, if the peak-to-peak value X of the FE signal is smaller than the reference value, the disc detection unit 205-2 determines that the optical disc 200 is an 8 cm fashion disc (OPERATION 313).

Then, the disc driving control unit 205-4 resets the parameters driving the optical disc 200 to meet the 8 cm fashion disc (OPERATION 314). The memory 206 stores various parameters driving the 8 cm fashion disc, such as levels of rotation speed, balance, loop gain, etc. The disc driving control unit 205-4 resets the driving condition of the optical disc 200 using the parameters stored in the memory 206.

As described above, according to the present invention, since fashion discs having various shapes can be accurately detected and optimum driving conditions for the fashion discs, such as speeds, loop gains, etc., can be adequately set, it is possible to prevent conventional instability problems when reproducing fashion discs and, accordingly, customer satisfaction can be improved.

While the present invention has been particularly shown and described with reference to preferred embodiments thereof, it will be understood by those of ordinary skill in the art that various changes in form and details may be made therein without departing from the spirit and scope of the present invention as defined by the appended claims.

What is claimed is:

1. A method of detecting an optical disc, comprising:
detecting a size of the optical disc inserted in an optical disc drive by sensing a weight of the optical disc and driving the optical disc drive;
determining the size of the optical disc by detecting an amount of data recorded on the optical disc from a lead-in area of the optical disc;
if the amount of data recorded on the optical disc, the size of which has been determined, is below a reference value, moving a pickup to a periphery area and measuring a focus error; and
if the measured focus error is above a constant value, detecting the optical disc as a certain optical disc type and limiting the operational speed level of the optical disc drive.

2. The method of claim 1, wherein the optical disc detected according to the weight thereof is either a standard disc having a diameter of 12 cm or a fashion disc having a diameter of 8 cm.

3. The method of claim 1, wherein the optical disc determined according to the amount of data recorded on the optical disc is any one disc among a standard disc having a diameter of 12 cm on which data is fully recorded, a standard disc having a diameter of 12 cm on which data is partially recorded, and a fashion disc having a diameter of 8 cm.

4. The method of claim 1, wherein the certain optical disc type is a fashion disc having a diameter of 8 cm.

5. The method of claim 1, wherein if the measured focus error is below the constant value, the optical disc is detected as a standard disc having a diameter of 12 cm on which data is partially recorded.

6. An apparatus detecting an optical disc, comprising:
a weight detection unit detecting a weight of the optical disc inserted in a disc drive;
a comparison unit comparing an amount of data recorded on the optical disc from the lead-in area of the optical disc with a reference value; and
a disc detection unit detecting a size of an optical disc according to the weight detected via the weight detection unit, determining the size of the optical disc by detecting the amount of data recorded on the optical disc from a lead-in area of the optical disc when the disc drive is driven, if determined as a result of the comparison via the comparison unit that the amount of data recorded on the optical disc is below the reference value, moving a pickup to a periphery area and measuring a focus error, and if the measured focus error is above a constant value, detecting the optical disc as a certain optical disc type.

7. The apparatus of claim 6, wherein the detection unit includes:
a first disc detection unit that detects the size of the disc according to the weight detected via the weight detection unit;
a second disc detection unit that determines the size of the optical disc by detecting the amount of data recorded on the optical disc from the lead-in area of the optical disc when the disc drive is driven; and
a third disc detection unit that moves the pickup to the periphery area and measures the focus error, if it is determined as the result of the comparison via the comparison unit that the amount of data recorded on the optical disc is below the reference value, and detects the optical disc as the certain optical disc type, if the measured focus error is above the constant value.

8. The apparatus of claim 7, wherein the first disc detection unit detects the optical disc as either a standard disc having a diameter of 12 cm or a fashion disc having a diameter of 8 cm according to the weight of the optical disc.

9. The apparatus of claim 7, wherein the second disc detection unit detects the optical disc as any one disc among a standard disc having a diameter of 12 cm on which data is fully recorded, a standard disc having a diameter of 12 cm on which data is partially recorded, and a fashion disc having a diameter of 8 cm according to the amount of data recorded on the optical disc.

10. The apparatus of claim 7, wherein the third disc detection unit detects the optical disc as a certain optical disc predetermined as a fashion disc having a diameter of 8 cm if the measured focus error is below the constant value and as a standard disc having a diameter of 12 cm on which data is partially recorded if the measured focus error is above the constant value.

11. An apparatus that identifies a type of an optical disc, comprising:
a weight measure unit that measures a weight of the optical disc;
a comparison unit comparing a data recording capacity of the optical disc with a reference value; and
a disc identification unit that determines a size of the optical disc according to the measured weight and the data recording capacity of the optical disc.

12. The apparatus of claim 11, further comprising:
a read unit that reads a lead-in area of the optical disc to determine the data recording capacity of the optical disc.

13. The apparatus of claim 11, further comprising:
a pickup that moves to a periphery area of the optical disc to measure a focus error;
a controller that determines that the optical disc is a first type if the measured focus error is above a constant value.

14. A disc drive that identifies a type of an optical disc, comprising:
a controller that identifies the type of the optical disc by a weight of the optical disc and a data recording capacity of the optical disc.

15. The disc drive of claim 14, further comprising:
a pickup that reads signals from the optical disc to produce an electrical signal;
a wave filtering rectifier that adds or subtracts the electrical signal to output a focus error signal; and
wherein the controller determines that the optical disc is a first type if a measured focus error from the focus error signal is above a constant value.

16. The disc drive of claim 15, further comprising:
a sled motor that moves the pickup;
a spindle motor that rotates the optical disc;
a driver that drives the sled motor and the spindle motor; and
a servo that controls the operations of the pickup and the driver.

17. A method of determining a diameter of an optical disc in an optical disc drive, comprising:
operating the optical disc drive;
sensing a weight of the optical disc during operation of the disc drive; and
determining the diameter of the optical disc from the weight of the optical disc.

18. A method of determining a diameter of an optical disc in an optical disc drive, comprising:
operating the optical disc drive;
reading a data recording capacity of the optical disc from a lead-in area of the optical disc;
determining the diameter of the optical disc from the data recording capacity.

19. The method of claim 18, further comprising:
comparing the data recording capacity to a reference value;
moving a pickup to a periphery area and measuring a focus error if the data recording capacity is below the reference value; and
wherein the determining the diameter comprises:
identifying the optical disc as a non-standard size and limiting the operational speed level of the optical disc drive if the measured focus error is above a constant value; or
identifying the optical disc as a standard size and running the optical disc drive at a normal speed level if the measured focus error is below the constant value.

20. A method of identifying a type of an optical disc inserted into a disc drive, comprising:
identifying the optical disc as a fashion disc having a diameter of 8 cm or as a standard disc having a diameter of 12 cm based on a weight of the optical disc; and
identifying the optical disc as a CD or as a DVD based on a thickness of the optical disc.

21. The method of claim 20, further comprising:
loading the optical disc on a tray; and
closing the tray to operate the disc drive.

22. The method of claim 21, further comprising:
turning on a focus servo;
reading a table of contents from a lead-in area of the optical disc;
detecting a data recording capacity of the optical disc from the table of contents;
determining whether the data recording capacity of the optical disc is consistent with a capacity of the 8 cm fashion disc.

23. The method of claim 21, further comprising:
adjusting parameters of the disc drive based on the type of the optical disc.

24. A method of identifying a type of an optical disc in a disc drive, comprising:
moving a focus lens through an operating range;
measuring a focus error while moving the focus lens;
comparing a peak-to-peak value of the measured focus error to a reference value; and
determining that the optical disc is a 12 cm standard disc if the peak-to-peak value is greater than the reference value or that the optical disc is an 8 cm fashion disc if the peak-to-peak value is less than the reference value.

25. The method of claim 24, further comprising:
operating the disc drive according to the determined type of the optical disc.

26. The method of claim 24, further comprising: moving a pickup to a periphery area of the optical disc to measure the focus error.

27. The method of claim 24, wherein the moving the focus lens through the operating range comprises moving the focus lens up and down.

28. The method of claim 24, further comprising:
adjusting operating parameters of the disc drive consistent with the 8 cm fashion disc.

29. The method of claim 28, further comprising:
storing operating parameters to drive the 8 cm fashion disc;
wherein the adjusting the operating parameters comprises adjusting the operating parameters based on the stored operating parameters.
